(19) United States
(12) Patent Application Publication
(10) Pub. No.: US 2023/0335851 A1
(43) Pub. Date: Oct. 19, 2023

(54) BATTERY MOUNTING SYSTEM FOR AN ELECTRIC VEHICLE

(71) Applicant: GM Global Technology Operations LLC, Detroit, MI (US)

(72) Inventors: Alexander M. Bilinski, Avoca, MI (US); Phillip Daniel Hamelin, Clarkston, MI (US); M. Saif Siddiqui, Troy, MI (US)

(21) Appl. No.: 17/720,725

(22) Filed: Apr. 14, 2022

(51) Int. Cl. H01M 50/249

(52) U.S. Cl. CPC H01M 50/249; H01M 2220/20

(57) ABSTRACT

A battery mounting system for a vehicle including a mounting member configured to connect to an underbody. The mounting member includes a first end, a second end, a first side, and a second side. The second end is opposite to and spaced from the first end along a first axis and the second side is opposite to and spaced from the first side along a second axis that is orthogonal to the first axis. A cross-member extends between the first side and the second side. The cross-member forms a first battery module zone and a second battery module zone. The second battery module zone being spaced from the first battery module zone along the first axis. A first battery module is arranged in the first battery module zone below the vehicle underbody and a second battery module is arranged in the second battery module zone below the vehicle underbody.

### INTRODUCTION

The subject disclosure relates to the art of vehicles and, more particularly, to a battery mounting system for an electric vehicle.

Electric and hybrid vehicles typically include a battery pack that provides power to an electric motor. The electric motor may a sole source of motive energy such as for an electric vehicle or the electric motor may work in conjunction with another motor as in the case of a hybrid vehicle. The another motor in a hybrid motor is often times an air breathing gas or diesel engine. Typically, the battery is mounted in a battery compartment and fitted with a protective cover. In many cases, the battery compartment is located below a rear seat or in another awkwardly accessible space inside the vehicle.

Given the position of the battery compartment in the vehicle, the battery is typically shielded from forces associated with forward and rear impacts. However, side impacts may generate forces that pass through the battery compartment and into the battery. Crash forces transferred into the battery can cause damage that necessitates battery replacement. Replacing a battery is a time consuming and costly process. Accordingly, it is desirable to provide system that provides protection to a battery from side impact forces and also facilitates a less labor intensive battery replacement.

### SUMMARY

Disclosed, in accordance with a non-limiting example, is a battery mounting system for a vehicle including a mounting member configured to connect to a vehicle underbody. The mounting member includes a first end, a second end, a first side, and a second side. The second end is opposite to and spaced from the first end along a first axis and the second side is opposite to and spaced from the first side along a second axis that is orthogonal to the first axis. A cross-member extends between the first side and the second side along the second axis. The cross-member forms a first battery module zone and a second battery module zone. The second battery module zone being spaced from the first battery module zone along the first axis. A first battery module is arranged in the first battery module zone below the vehicle underbody and a second battery module is arranged in the second battery module zone below the vehicle underbody.

In addition to one or more of the features described above or below, or as an alternative, further embodiments could include wherein the mounting member includes a first side member defining the first side, a second side member defining the second side, a first end member defining the first end, and a second end member defining the second end.

In addition to one or more of the features described above or below, or as an alternative, further embodiments could include wherein each of the first side member and the second side member includes a first surface and a second surface that is opposite the first surface and each of the first end member and the second end member includes a first surface portion and a second surface portion that is opposite the first surface portion, the first surface and the first surface portion being configured to face the vehicle underbody when the battery mounting system is mounted to the vehicle.

In addition to one or more of the features described above or below, or as an alternative, further embodiments could include a first shear plate mounted to each of the first surface and the first surface portion and a second shear plate mounted to each of the second surface and the second surface portion, the second shear plate covering the first battery module and the second battery module and defining an exterior surface of the battery mounting system.

In addition to one or more of the features described above or below, or as an alternative, further embodiments could include wherein each of the first battery module and the second battery module is connected to the second shear plate.

In addition to one or more of the features described above or below, or as an alternative, further embodiments could include wherein the first surface is spaced from the corresponding second surface defining a width of the mounting member, the cross-member having a width that is substantially equal to the width of the mounting member.

In addition to one or more of the features described above or below, or as an alternative, further embodiments could include wherein the cross-member is spaced from one of the first shear plate and the second shear plate.

In addition to one or more of the features described above or below, or as an alternative, further embodiments could include wherein the cross-member is spaced from the first shear plate.

In addition to one or more of the features described above or below, or as an alternative, further embodiments could include further comprising a vehicle interface member that provides a pathway for conductors passing from one of the first battery module and the second battery module into the vehicle.

Disclosed, in accordance with another non-limiting example, is a vehicle including an underbody having a lower surface and a battery mounting system mounted to the underbody. The battery system includes a mounting member supported at the lower surface. The mounting member includes a first end, a second end, a first side, and a second side, the second end is opposite to and spaced from the first end along a first axis and the second side is opposite to and spaced from the first side along a second axis that is orthogonal to the first axis. A cross-member extends between the first side and the second side along the second axis. The cross-member forms a first battery module zone and a second battery module zone. The second battery module zone is spaced from the first battery module zone along the first axis. A first battery module is arranged in the first battery module zone below the underbody and a second battery module is arranged in the second battery module zone below the underbody.

In addition to one or more of the features described above or below, or as an alternative, further embodiments could include wherein the mounting member includes a first side member defining the first side, a second side member defining the second side, a first end member defining the first end, and a second end member defining the second end.

In addition to one or more of the features described above or below, or as an alternative, further embodiments could include wherein each of the first side member and the second side member includes a first surface and a second surface that is opposite the first surface and each of the first end member and the second end member includes a first surface portion and a second surface portion that is opposite the first surface portion the first surface and first surface portion being configured to face the underbody when the battery system is mounted to the vehicle.

In addition to one or more of the features described above or below, or as an alternative, further embodiments could include a first shear plate mounted to the first surface and the first surface portion and a second shear plate mounted to the second surface and the second surface portion, the second shear plate covering the first battery module and the second battery module and defining an exterior surface of the battery system.

In addition to one or more of the features described above or below, or as an alternative, further embodiments could include wherein each of the first battery module and the second battery module is connected to the second shear plate.

In addition to one or more of the features described above or below, or as an alternative, further embodiments could include wherein each first surface is spaced from the corresponding second surface a first distance defining a width of the mounting member, the cross-member having a width that is substantially equal to the width of the mounting member.

In addition to one or more of the features described above or below, or as an alternative, further embodiments could include wherein the cross-member is spaced from one of the first shear plate and the second shear plate.

In addition to one or more of the features described above or below, or as an alternative, further embodiments could include wherein the cross-member is spaced from the first shear plate.

In addition to one or more of the features described above or below, or as an alternative, further embodiments could include a vehicle interface member that provides a pathway for conductors passing from one of the first battery module and the second battery module into the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a lower perspective disassembled view of a vehicle underbody and battery mounting system, in accordance with a non-limiting example;

FIG. 2 is a disassembled view of the battery mounting system of FIG. 1, in accordance with a non-limiting example; and

FIG. 3 is a detail view of a side member and a first end of a cross-member of the battery mounting system of FIG. 2, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

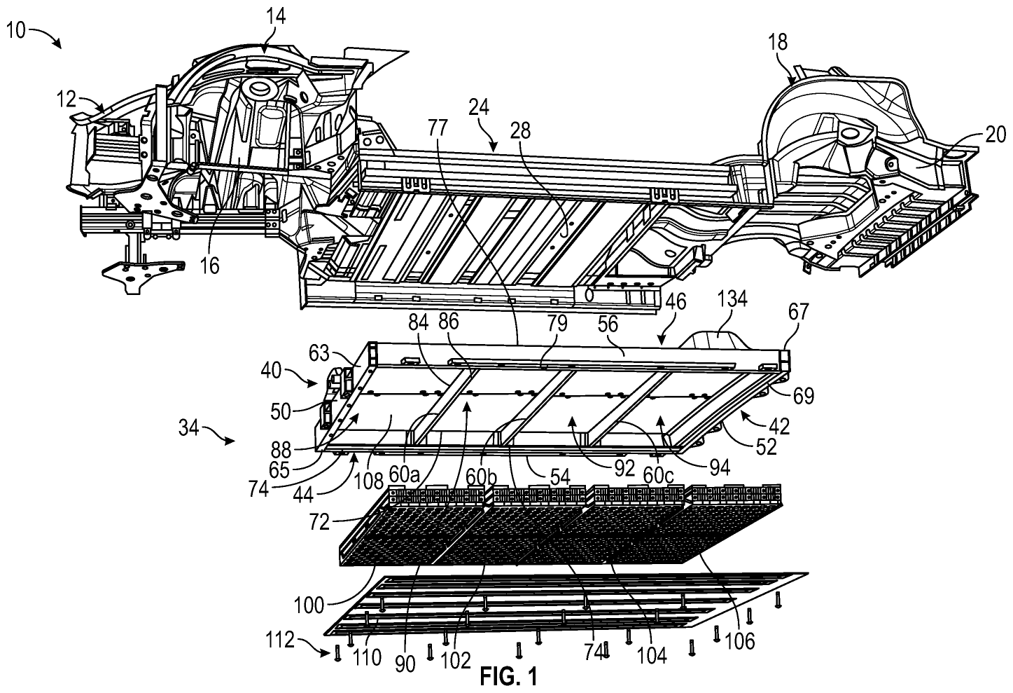

A vehicle, in accordance with a non-limiting example, is indicated generally at 10 in FIG. 1. Vehicle 10 includes an underbody 12 having a left front quadrant 14 defining a left front wheel well 16 and a left rear quadrant 18 defining a left rear wheel well 20. A floor 24 extends between left front quadrant 14 and left rear quadrant 18. Floor 24 includes a lower surface 28. Vehicle 10 includes additional components including a body, wheels, and an electric motor (not shown).

In a non-limiting example, vehicle 10 includes a battery mounting system 34 mounted to lower surface 28. As will be detailed herein, battery mounting system 34 supports battery modules that provide electric power to vehicle 10. In a non-limiting example, battery mounting system 34 includes a first end 40, a second end 42, a first side 44 and a second side 46. Second end 42 is opposite to first end 40 and second side 46 is opposite first side 44. In a non-limiting example, first end 40 is defined by a first end member 50, second end 42 is defined by a second end member 52, first side 44 is defined by a first side member 54, and second side 46 is defined by a second side member 56.

In a non-limiting example, battery mounting system 34 includes a first cross-member 60a, a second cross-member 60b, and a third cross-member 60c. First cross-member 60a extends between first side member 54 and second side member 56 and is spaced from first end member 50. Second cross-member 60b extends between first side member 54 and second side member 56 and is spaced from first cross-member 60a. Third cross-member 60c extends between first side member 54 and second side member 56 and is spaced from second cross-member 60b and second end member 52.

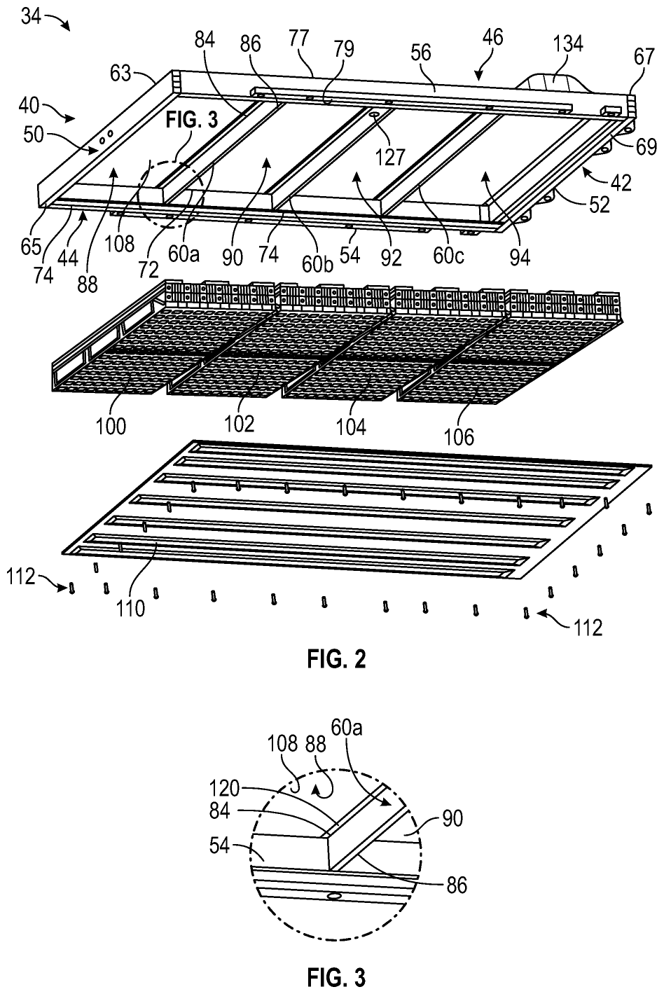

Referring to FIG. 2 and with continued reference to FIG. 1, first end member 50 includes a first surface 63 and a second surface 65. Second surface 65 is opposite to first surface 63 and defines a width of first end member 50. Second end member 52 includes a first surface 67 and a second surface 69 that is opposite to first surface 67. First surface 67 is spaced from second surface 69 to define a width of second end member 52. In a non-limiting example, first side member 54 includes a first surface portion 72 and a second surface portion 74. Second surface portion 74 is spaced from first surface portion 72 to define a with of first side member 54. Second side member 56 includes a first surface portion 77 and a second surface portion 79. Second surface portion 79 is opposite first surface portion 77 and defines a width of second side member 56. In a non-limiting example, the widths of the first end member 50, second end member 52, first side member 54 and second side member 56 are substantially identical and thus form a depth of battery mounting system 34.

In a non-limiting example, each of first cross-member 60a, second cross-member 60b, and third cross-member 60c includes a first surface section 84 and a second surface section 86 such as shown in connection with first cross-member 60a. Second surface section 86 is opposite to first surface section 84 and defines a width of each cross-member 60a-60c. The width of each cross-member 60a-60c is substantially identical to the width of first side member 54 and second side member 56. With this arrangement, any impact forces that may be perceived by first side member 54 or second side member 56 are transferred to the opposing one of first side member 54 and second side member 56. That is, each cross-member 60a-60c by having a width that is similar to each of the first and second side members 54 and 56 transfers and absorbs impact forces to protect batteries as will be detailed herein.

In a non-limiting example, a first battery module zone 88 is defined between first end member 50 and first cross-member 60a, a second battery module zone 90 is defined between first cross-member 60a and second cross-member 60b, a third battery module zone 92 is defined between second cross-member 60b and third cross-member 60c, and a fourth battery module zone 94 is defined between third cross-member 60c and second end member 52. In a non-limiting example, a first battery module 100 is mounted in first battery module zone 88, a second battery module 102 is mounted in second battery module zone 90, a third battery module 104 is mounted in third battery module zone 92, and a fourth battery module 106 is mounted in fourth battery module zone 94.

In a non-limiting example, a first shear plate 108 is mounted to first surface, first surface portion, and first surface section of each of first end member 50, second end member 52, first side member 54, second side member 56 and each cross-member 60a-60c. A second shear plate 110 is mounted to the second surface, second surface portion, and second surface section of each of first end member 50, second end member 52, first side member 54, second side member 56 and each cross-member 60a-60b so as to define an exterior surface (not separately labeled) of battery mounting system 34. In a non-limiting example, each battery module 100, 102, 104, and 106 is mounted to second shear plate 110 through a plurality of mechanical fasteners indicated generally at 112. With this arrangement, cross-members 60a-60c together with first and second shear plates 108 and 110 provide energy absorbing path ways that shield battery modules 100, 102, 104, and 106 from side impact forces.

In a non-limiting example depicted in FIG. 3, first surface section 84 of first cross-member 60a may be spaced from first shear plate 108 so as to form a gap 120. Gap 120 provides a pathway allowing conductors (not shown) to pass from first battery module zone 88 into second battery module zone 90. Similar gaps (not separately labeled) may exist between cross-members 60b and 60c and shear plate 108. In another non-limiting example, the gaps may be present between cross-members 60a-60c and second shear plate 110.

In a non-limiting example, battery mounting system 34 also includes a vehicle interface member 134 that provides a path for passing the conductors from each battery module 100, 102, 104, and 106, in each battery module zone 88, 90, 92, and 94 into vehicle 10. The conductors may pass to battery controllers and/or the vehicle motor. Gap 120 may also allow gases to pass from each battery module zone 88, 90, 92 and 94. At this point it should be understood that the battery mounting system 34 in accordance with non-limiting examples provides structure support that protects battery modules from side impact loads but also allows battery modules to be accessed by simply removing a shear plate from below the vehicle.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A battery mounting system for a vehicle comprising:
a mounting member configured to connect to a vehicle underbody, the mounting member including a first end, a second end, a first side, and a second side, the second end is opposite to and spaced from the first end along a first axis and the second side is opposite to and spaced from the first side along a second axis that is orthogonal to the first axis;
a cross-member extending between the first side and the second side along the second axis, the cross-member forming a first battery module zone and a second battery module zone, the second battery module zone being spaced from the first battery module zone along the first axis;
a first battery module arranged in the first battery module zone below the vehicle underbody; and
a second battery module arranged in the second battery module zone below the vehicle underbody.

2. The battery mounting system according to claim 1, wherein the mounting member includes a first side member defining the first side, a second side member defining the second side, a first end member defining the first end, and a second end member defining the second end.

3. The battery mounting system according to claim 2, wherein each of the first side member and the second side member includes a first surface and a second surface that is opposite the first surface and each of the first end member and the second end member includes a first surface portion and a second surface portion that is opposite the first surface portion the first surface and the first surface portion being configured to face the vehicle underbody when the battery mounting system is mounted to the vehicle.

4. The battery mounting system according to claim 3, further comprising a first shear plate mounted to each of the first surface and the first surface portion and a second shear plate mounted to each of the second surface and the second surface portion, the second shear plate covering the first battery module and the second battery module and defining an exterior surface of the battery mounting system.

5. The battery mounting system according to claim 4, wherein each of the first battery module and the second battery module is connected to the second shear plate.

6. The battery mounting system according to claim 3, wherein the first surface is spaced from the corresponding second surface defining a width of the mounting member, the cross-member having a width that is substantially equal to the width of the mounting member.

7. The battery mounting system according to claim 4, wherein the cross-member is spaced from one of the first shear plate and the second shear plate.

8. The battery mounting system according to claim 7, wherein the cross-member is spaced from the first shear plate.

9. The battery mounting system according to claim 1, further comprising a vehicle interface member that provides a pathway for conductors passing from one of the first battery module and the second battery module into the vehicle.

10. A vehicle comprising:
an underbody having a lower surface; and
a battery mounting system mounted to the underbody, the battery system comprising:
a mounting member supported at the lower surface, the mounting member including a first end, a second end, a first side, and a second side, the second end is opposite to and spaced from the first end along a first axis and the second side is opposite to and spaced from the first side along a second axis that is orthogonal to the first axis;
a cross-member extending between the first side and the second side along the second axis, the cross-member forming a first battery module zone and a second battery module zone, the second battery module zone being spaced from the first battery module zone along the first axis;
a first battery module arranged in the first battery module zone below the underbody; and
a second battery module arranged in the second battery module zone below the underbody.

11. The vehicle according to claim 10, wherein the mounting member includes a first side member defining the first side, a second side member defining the second side, a first end member defining the first end, and a second end member defining the second end.

12. The vehicle according to claim 11, wherein each of the first side member and the second side member includes a first surface and a second surface that is opposite the first surface and each of the first end member and the second end member includes a first surface portion and a second surface portion that is opposite the first surface portion the first surface and first surface portion being configured to face the underbody when the battery system is mounted to the vehicle.

13. The vehicle according to claim 12, further comprising a first shear plate mounted to the first surface and the first surface portion and a second shear plate mounted to the second surface and the second surface portion, the second shear plate covering the first battery module and the second battery module and defining an exterior surface of the battery system.

14. The vehicle according to claim 13, wherein each of the first battery module and the second battery module is connected to the second shear plate.

15. The vehicle according to claim 12, wherein each first surface is spaced from the corresponding second surface a first distance defining a width of the mounting member, the cross-member having a width that is substantially equal to the width of the mounting member.

16. The vehicle according to claim 13, wherein the cross-member is spaced from one of the first shear plate and the second shear plate.

17. The vehicle according to claim 16, wherein the cross-member is spaced from the first shear plate.

18. The vehicle according to claim 10, further comprising a vehicle interface member that provides a pathway for conductors passing from one of the first battery module and the second battery module into the vehicle.
